(19) United States
(12) Patent Application Publication
(10) Pub. No.: US 2021/0072619 A1
(43) Pub. Date: Mar. 11, 2021

(54) PHOTOGRAPHY LIGHTING APPARATUS AND METHOD THEREOF

(71) Applicant: Robert Weidenfeld, Henderson, NV (US)

(72) Inventor: Robert Weidenfeld, Henderson, NV (US)

(21) Appl. No.: 16/563,961

(22) Filed: Sep. 9, 2019

(51) Int. Cl. G03B 15/02; H05B 33/08; H05B 37/02

(52) U.S. Cl. CPC G03B 15/02; H05B 37/0209; H05B 33/0863

(57) ABSTRACT

A device for generating lighting, having a container; at least one arm attached to the container; a light source is attached to the other end of the arm, the container is configured to change the state of the light source between an on and an off condition. The intensity of the light source can be changed from full dim to fully bright. Modifiers are used to change the focus of the light and color filters are used to change the color of the light. A plurality of light sources attached to the container. A plurality of switches are connected to the plurality of light sources for providing current to the plurality of light sources. Plurality of switches are configured to control the light intensity.

### BACKGROUND

Table top photography is an area of photography with its special needs. In table top photography, objects to be photographed are placed on a table top and light is provided to get a good picture. Light can be provided from multiple sources. While there are different light sources in the current art, a photographer has to collect multiple light sources and place them in proper locations to obtain desired results. Factors which further complicate the process are the color temperature of a given light source, intensity of a given light source and how to mix and match different light sources to provide a lighting environment that a photographer is seeking.

Providing light sources at a desired position with a desired color temperature, intensity and focus is very important for table top photography. Currently there is no apparatus that gives a photographer the flexibility needed. For example, a single light source can be attached to a fixed location and the light source would have a fixed intensity, focus and color temperature. When a light source with these features is used, while the location can be changed, it is difficult for a photographer to place this light source exactly at the point the photographer needs. Additionally, the intensity, focus and color temperature of the light source are fixed. If the photographer wants to change the intensity, focus or color temperature of the light to provide a different impression in the photograph, the photographer would have to use a different light source altogether. It becomes a difficult and cumbersome task for a photographer to address the issues of light from different locations with a desired intensity, focus and color temperature.

There is currently no device that solves all the shortcomings mentioned above.

### SUMMARY

The invention enables one to build a device that overcomes the shortcomings of the existing art.

One object of the invention is to provide a device that has multiple light sources where the light sources are connected to a box and attached to the box with flexible and moveable connecting arms. Connecting arms are adjustable and allows a photographer to adjust the position of a given light source.

Another object of the invention is to provide a device that has multiple light sources where the light sources are connected to a box and attached to the box with flexible and moveable connecting arms and the angle of the light with respect to a center axis from the light source can be adjusted either by using manual add on modifiers or by automatically, therefore, changing the focus of the light generated by the light source.

Another object of the invention is to provide a device that has multiple light sources where the light sources are connected to a box and attached to the box with flexible and moveable connecting arms and the intensity and the color of the light from the light source can be controlled.

Another object of the invention is to provide a device that has multiple light sources where the light sources are connected to a box and attached to the box with flexible and moveable connecting arms where the arms can be adjusted by the user manually.

Another object of the invention is to provide a device that has multiple light sources where the light sources are connected to a box and attached to the box with flexible and moveable connecting arms where the arms can be adjusted by the user automatically.

Another object of the invention is to provide a device that has multiple light sources where the light sources are connected to a box and attached to the box with flexible and moveable connecting arms where a user can enter the desired lighting set up into the system and the system adjusts the locations of the lights, the focus of the lights, and the color temperature of the light from a light source automatically.

Other objects of the invention will be clear when the details of the embodiments of the invention are described below.

### DESCRIPTION OF DRAWINGS

FIG. 1 shows perspective view of the device with four light sources are connected to a box with flexible arms.

FIG. 2 shows the inside details of the box in FIG. 1.

FIG. 3 shows the details of the box in FIG. 1 with power adaptor.

FIG. 4 shows the details of the box with controller circuit.

FIG. 5 shows the details of the box with knobs to adjust the light intensity of light sources.

FIG. 6 shows a light source with multiple light emitting diodes.

FIG. 7 shows the details of the box with multiple switches for different light emitting diodes in a light source.

FIG. 8 shows the details of the box where a controller is located in the box.

FIG. 9 shows the algorithm to provide desired color temperatures.

FIG. 10 shows the algorithm to control the device automatically based on the desired light intensity, light focus and color temperature.

FIG. 11 shows the internal details of a controller.

FIG. 12 shows different add on devices to control the focus of the light generated by light sources.

FIG. 13 shows a light generated by a light source.

### DETAILED DESCRIPTION OF THE EMBODIMENTS

The invention is disclosed in detail by describing different embodiments. These embodiments are considered to be different implementations of the invention and these embodiments do not limit the invention to the described embodiments.

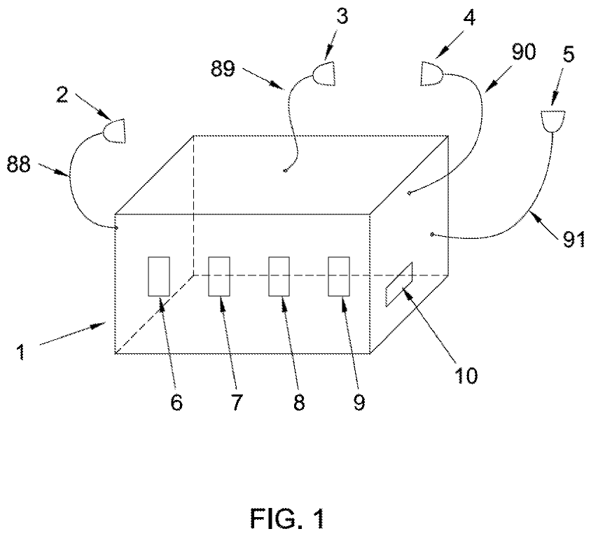

FIG. 1 shows the first embodiment of the invention. In this embodiment, the table top photography light source includes box 1. Box 1 can be made of any proper material such as plastics, metal, or wood, or any other suitable material. If a conductive material such as metal is used, proper insulation should be provided inside the box to make sure the box does not interfere with the current flow from current source to a plurality of light sources. Box 1 includes a plurality of switches 6, 7, 8, and 9. In this embodiment, four switches are shown. However, the invention is not limited by four switches only. There can be one or more switches installed on box 1. Light source 2 is attached to box 1 by flexible arm 88. Light source 3 is attached to box 1 by flexible arm 89. Light source 4 is attached to box 1 by flexible arm 90. Light source 5 is attached to box 1 by flexible arm 91. Flexible arm 88, flexible arm 89, flexible arm 90 and flexible arm 91 can be made of any material that are capable to be bent such as plastics, latex, rubber, metal or other suitable material. Current carrying cables are inserted in flexible arms 88, 89, 90, and 91. Current carrying cables can be built from metal cables or fiber cables. Box 1 includes a power connector 10. A DC power is connected to connector 10. Connector 10 is connected to switches 6, 7, 8, and 9 inside box 1. When power is applied to connector 10, each switch is manually controlled by a user to turn the light sources on or off. For example, if switch 6 is turned on such that a current flow from the DC source is allowed to flow to light source 2, light source 2 will light up. The location of light source 2 can be adjusted by changing the location of arm 88 and bending arm 88 to a desired position. For example, if switch 7 is turned on such that a current flow from the DC (Direct Current) or AC (Alternating Current) source is allowed to flow to light source 3, light source 3 will light up. If the power source is DC source, it can be supplied through any connector. An example is a USB (Universal Serial Bus) connector. The location of light source 3 can be adjusted by changing the location of arm 89 and bending arm 89 to a desired position. For example, if switch 8 is turned on such that a current flow from the DC source is allowed to flow to light source 4, light source 4 will light up. The location of light source 4 can be adjusted by changing the location of arm 90 and bending arm 90 to a desired position. For example, if switch 9 is turned on such that a current flow from the DC or AC source is allowed to flow to light source 5, light source 5 will light up. The location of light source 5 can be adjusted by changing the location of arm 91 and bending arm 91 to a desired position. While there are four light sources 2, 3, 4, and 5 shown in this first embodiment, there can be one or more light sources. Furthermore, while only four switches 6, 7, 8, and 9 are shown in this first embodiment, there can be one switch corresponding to a single light source or there can be multiple switches connected to multiple light sources. In this embodiment, the length of arm 88, 89, 90, and 91 are set long enough to be able to adjust arms 88, 89, 90, and 91 to place light source 2, 3, 4, and 5 in corresponding desired positions. The location where arm 88, arm 89, arm 90, and arm 91 are attached to box 1 can be any suitable location. Arm 88 can be attached to box 1 by creating a hole on the surface of box 1 and screwing arm 88 into the hole made on box 1 surface. Arm 89, 90, and 91 can be attached to box 1 the same way as described for arm 88. Alternatively, box 1 and arms 88, 89, 90, and 91 can all be built together as a single structure. The attachment of arms 88, 89, 90, and 91 can be attached to box 1 by using any means that can be used in the current art.

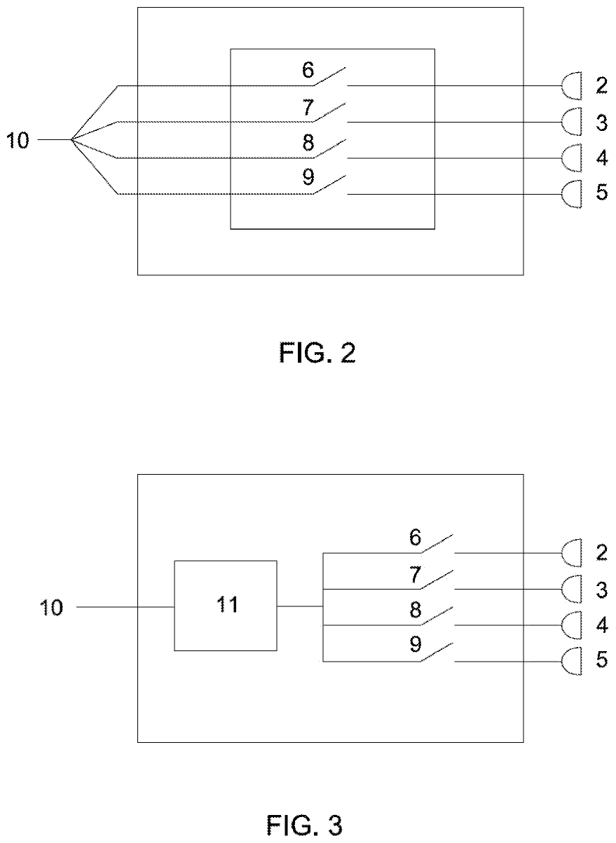

FIG. 2 shows the inside structure of box 1 for the first embodiment. FIG. 2 shows how switches 6, 7, 8, and 9 are connected to light sources 2, 3, 4, and 5 respectively. When switch 6 is turned on, current source is connected to light source 2 via connector 10. The current causes light source 2 to emit light. When switch 7 is turned on, current source is connected to light source 3 via connector 10. The current causes light source 3 to emit light. When switch 8 is turned on, current source is connected to light source 4 via connector 10. The current causes light source 4 to emit light. In this embodiment, switches 6, 7, 8, and 9 are controlled manually. While there are four switches and four light sources shown in this embodiment, there may be only one or more number of switches and light sources.

FIG. 3 shows another embodiment of the invention. In this embodiment, an alternating current is applied to connector 10 and power rectifier 11 is used to convert alternating current to direct current. Direct current is applied to switches 6, 7, 8, and 9. In this embodiment switch 6 is connected to light source 2, switch 7 is connected to light source 3, switch 8 is connected to light source 4 and switch 9 is connected to light source 5. While there are four switches and four light sources shown in this embodiment, there may be only one or more number of switches and light sources.

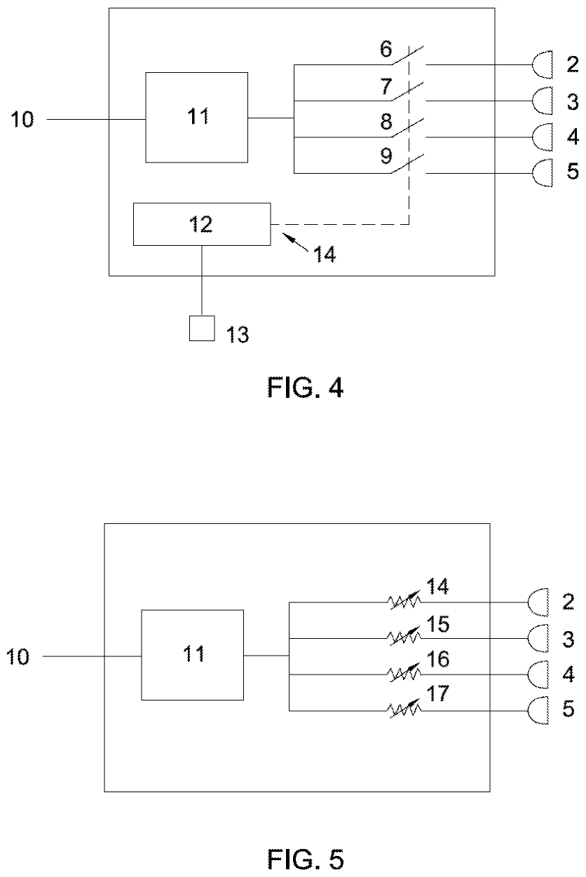

FIG. 4 shows another embodiment of the invention. In this embodiment, instead of manually controlling switches 6, 7, 8, and 9, an auto control mechanism is used. The auto control mechanism includes controller 12, connector 13 and connector 14. Controller 12 has a control circuit where a signal from outside a computer or a cell phone or any other controller is applied to connector 13. The signal applied to connector 13 carries the information as to if switches 6, 7, 8, and 9 should be in an on or off position where the on position is defined as the current going through switches 6, 7, 8, and 9 and off position means current is blocked by switches 6, 7, 8, and 9. Switch 6, switch 7, switch 8, and switch 9 can all be controlled individually. In this embodiment, an example of switch 6, 7, 8, and 9 can be relays or solid state circuits where when a current is applied to the relay, a contact is provided for current flow. If a solid state circuit is used, the solid state circuit can be controlled by the signals coming from connector 14.

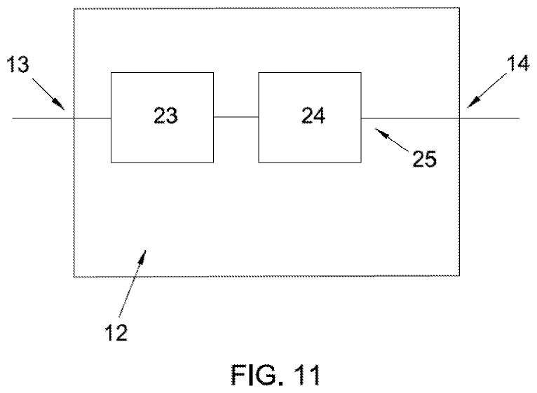

FIG. 5 shows another embodiment where the amount of current supplied to light source 2 is adjusted by adjusting the resistance of potentiometer 14. While a potentiometer can be used, alternatively, a solid state circuit can also be used to control the amount of current flow to light source 2. By changing the current flow to light source 2, the intensity of light emitted by light source 2 can be adjusted. The amount of current supplied to light source 3 is adjusted by adjusting the resistance of potentiometer 15. While a potentiometer can be used, alternatively, a solid state circuit can also be used to control the amount of current flow to light source 3. By changing the current flow to light source 3, the intensity of light emitted by the light source can be adjusted. The amount of current supplied to light source 4 is adjusted by adjusting the resistance of potentiometer 16. While a potentiometer can be used, alternatively, a solid state circuit can also be used to control the amount of current flow to light source 4. By changing the current flow to light source 4, the intensity of light emitted by light source 4 can be adjusted. The amount of current supplied to light source 5 is adjusted by adjusting the resistance of potentiometer 17. While a potentiometer can be used, alternatively, a solid state circuit can also be used to control the amount of current flow to light source 5. By changing the current flow to light source 5, the intensity of light emitted by light source 5 can be adjusted. The change can be done by knobs that can be attached to box 1. Each knob controls one potentiometer or solid state circuit. While the current flow to light sources 2, 3, 4, and 5 can be changed manually, the change can also be done automatically by using controller described as in FIG. 4. When an automatic control is used, a signal is sent to controller 12 and signal includes information about the amount of intensity desired for each light source. Controller 12 decodes the signal and uses the information to control adjusters 14, 15, 16, and 17. Controller 12 includes a communication circuit 23 and a processor 24 as shown in FIG. 11. A signal carrying intensity information is applied to communication circuit through connector 13. Communication circuit 23 converts the signal as required and applied it to processor 24. The output 25 of processor 24 is applied to adjusters 14, 15, 16, and 17. While only one line 25 is shown, it is obvious that to control multiple light adjusters 14, 15, 16, and 17, there has to be multiple lines from processor 24.

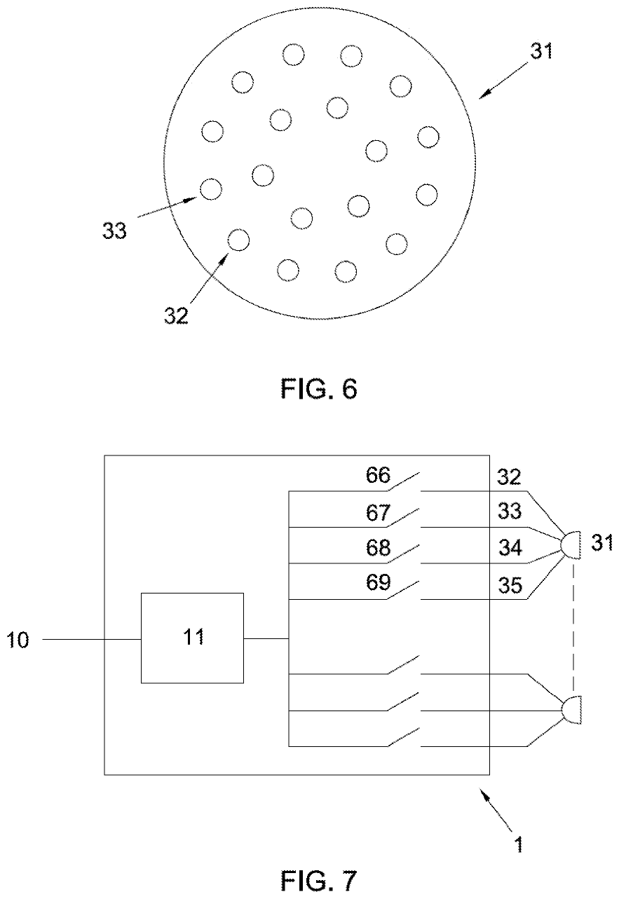

FIG. 6 shows an embodiment of the invention including light source 31 with multiple light emitting diodes. Only light emitting diode 32 and 33 are marked. All other light emitting diodes are similar to light emitting diode 32 and 33. Each light emitting diode 32 is designed and manufactured to have a predetermined light intensity and light color temperature. Therefore, two different light emitting diodes for example light emitting diode 32 and light emitting diode 33 may have different characteristics, for example, if the same amount of current is applied to both light emitting diode 32 and light emitting diode 33, light emitting diode 32 may emit a light with different intensity than a light emitted by light emitting diode 33. Also, for the same amount of current applied to both light emitting diode 32 and light emitting diode 33, the color temperature of the light generated by light source 32 would be different than the color temperature of the light emitted by light source 33. By distributing light emitting diodes with different characteristics within the light source, and using these characteristics, different light conditions at different light intensity and color temperature can be obtained.

FIG. 7 shows another embodiment where a light source as in FIG. 6 is used in a table top photography lighting box such that different light emitting diodes in light source 31 are controlled individually. Switch 66 is connected to light emitting diode 32, switch 67 is connected to light emitting diode 33, switch 68 is connected to light emitting diode 34, switch 69 is connected to light emitting diode 35. While there are four switches and four light emitting diodes shown in FIG. 7, the embodiment and the invention is not limited by the number of switches and the number of light emitting diodes. Any number of light emitting diodes and switches can be used. In certain embodiments, the same switch may turn on and off multiple light emitting diodes. Switches 66, 67, 68, 69 in FIG. 7 can be manually operated to turn on and off light emitting diodes 32, 33, 34, and 35. This way, each light emitting diode emits light in a predetermined color temperature. The light intensity from each light emitting diode can be adjusted as described in FIG. 5. While this embodiment shows that there is adaptor 11 in box 1, it is possible to have a variation where there is no adaptor in box 1 and DC current is directly applied to switches 66, 67, 68, and 69 through connector 10. The end result is similar where DC current is either applied or not applied to switches 66, 67, 68, and 69. The DC current causes light emitting diodes 32, 33, 34, 35 to emit light in predetermined color temperature and intensity.

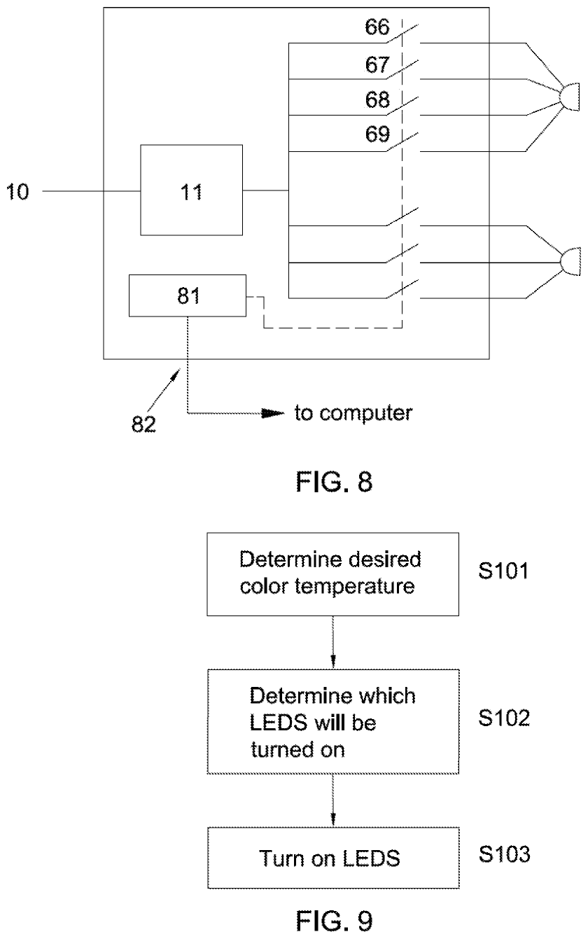

FIG. 8 shows another embodiment where switches 66, 67, 68, and 69 are controlled by controller 81 automatically based on the commands coming from a computer through port 82 of box 1. Commands from a computer are sent to box 1, based on an input by a user. The flow diagram of the process is shown in FIG. 9. In step 101, a user defines desired color temperature. In step 102, the algorithm determines what light emitting diodes need to be turned on based on the desired color temperature. Determining which light emitting diode should be turned on depends on the number of light emitting diodes, the distribution of plurality of light emitting diodes within a light source, and the selected color temperature of each light emitting diode. Once the determination by the algorithm is made as to which light emitting diodes should be turned on, proper commands are sent to switches 66, 67, 68, and 69 from controller 81. Based on these commands, switches 66, 67, 68, and 69 are turned on or off to obtain a desired color temperature. Different components can be used as switches in this automated set up. For example, relays or solid circuit switches can be used to control the current flow to light emitting diodes.

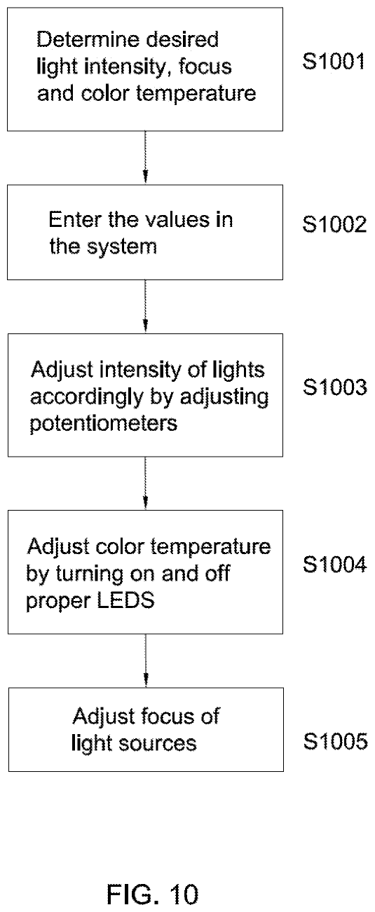

FIG. 10 shows the flow diagram where the characteristics of light emitted by each light source attached to box 1 is controlled. In step S1001, a user determines the desired intensity, focus and color temperature for light emitted from light sources. In step S1002, a user enters the values determined in step S1001 into the system. In step 1003, intensity of lights are adjusted by adjusting potentiometers or solid state circuits. In step S1004, based on the desired color temperature, switches are turned on or off to control the current flow to a plurality of light emitting diodes. Furthermore, the focus of each light from light sources are also adjusted. This way, the color temperature, the intensity and the focus of light in the environment are controlled by the system.

FIG. 11 shows the internal details of controller 12. Communication circuit 23 and processor 24 are placed in controller 12. Communication circuit 23 provides communication with outside computer or other devices. Processor 24 performs instructions based on the information coming from outside devices and the output of the processor is connected to switches and other elements within box 1.

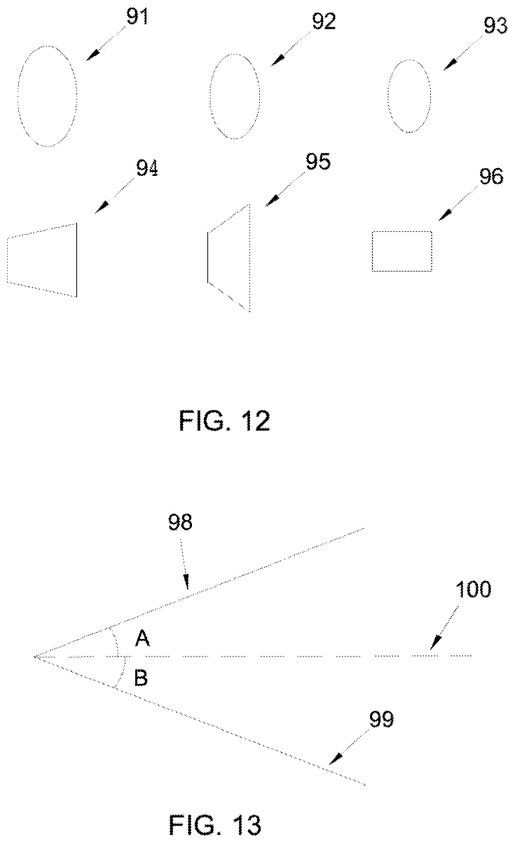

FIG. 12 shows different add on devices to control the focus and color of the light generated by light sources 2, 3, 4, and 5. Different color filters 91, 92, and 93 can be used to place over the light source to change the color of the light emitted from the light sources 2, 3, 4, and 5. Color filters 91, 92, and 93 are made of any suitable material. For example, plastic, glass and other suitable material can be used. The light emitted from the light sources 2, 3, 4, and 5 can be controlled by adding focus changing devices 94, 95, and 96. Focus changing devices 94, 95, and 96 can be made of any suitable material such as plastic, metal or any other suitable material. As shown in FIG. 12, focus changing device 95 allows the light generated by the light sources 2, 3, 4, and 5 to have a wider focus than the focus of the light controlled by focus changing device 96.

FIG. 13 shows a light generated by a light source. Angle A between central axis 100 and the edge 98 determines how focused the light is. Angle A can be changed by using focus changing devices 94, 95, or 96. While three focus changing devices 94, 95, and 96 are discussed here, the invention is not limited to three focus changing devices only. There may be one or any number of focus modifiers and color filters. Angle B is the angle between central axis 100 and other edge 99 of the light. While angle A and angle B are equal to each other, they may be different angles in different embodiments.

In another embodiment of the invention, focus changing devices 94, 95, and 96 are controlled by a mechanism where focus can be adjusted automatically by a computer or a controlling device. In this embodiment, light sources 2, 3, 4, and 5 attached to box 1 can be controlled by a computer to adjust intensity of the light, color of the light, focus of the light, color temperature of the light emitted by light sources 2, 3, 4, and 5. This is a fully automated control system. This way, a user enters the parameters of desired light in an environment for table top photography, and the system generates proper light conditions by adjusting the parameters such as current applied to light sources, different color filters, focus changing devices. The locations of light sources 2, 3, 4, and 5 can also be adjusted automatically. Finally, all these operations can also be performed manually or in combination of manual and automatic adjustment.

1. A device for generating lighting, the device comprising: a container; an input port for applying power to the container; at least one arm; wherein one end of the at least one arm is attached to the container; a light source is attached to the other end of the at least one arm, wherein the container is configured to change the state of the light source between an on and an off condition.

2. The device of claim 1, wherein there are plurality of light sources attached to the container, the container further comprises plurality of switches attached to the container, and the plurality of switches are connected to the plurality of light sources for providing current to the plurality of light sources so that when any one of the plurality of switches is in a current conducting state, any one of the plurality of the light sources that are connected to the plurality of switches that are in the current conducting state will produce light.

3. The device of claim 1, wherein the arm is made of a material that is flexible and the arm can be bent to change a position of the light source.

4. The device of claim 2, wherein the switch can be either a mechanical switch or a solid state switch and the plurality of light sources can be controlled either by mechanical means or automatic means.

5. The device of claim 4 wherein direct current is applied to the input port.

6. The device of claim 4, wherein the container further comprises a rectifier circuit and an alternating current is applied to the input port and the alternating current is converted to a direct current within the container.

7. The device of claim 4 wherein the container further comprises a controller for controlling a plurality of states of the plurality of switches.

8. The device of claim 7 wherein the controller is connected to a computing device such as a computer or an IPAD or a mobile device which is located outside the container.

9. A focus adjusting apparatus that can be attached to a light source to adjust an angle of a light emitted by the light source.

10. The focus adjusting apparatus of claim 9, wherein the focus adjusting apparatus has a predetermined shape for adjusting a light focus generated by a light source when the focus adjusting apparatus is attached to a light source.

11. A light source comprising at least one light emitting diode wherein the light emitting diode is manufactured based on a plurality of predetermined characteristics of a light emitted by the light emitting diode, wherein the plurality of predetermined characteristics of the light include a color temperature, an intensity of the light, and the focus of the light.

12. The light source of claim 11 wherein a distribution of the light emitting diodes in the light source can vary.

13. The device of claim 1 wherein the light source comprises at least one light emitting diode wherein the light emitting diode is manufactured based on a plurality of predetermined characteristics of a light emitted by the light emitting diode, wherein the plurality of predetermined characteristics of the light include a color temperature, an intensity of the light, and the focus of the light.

14. The device of claim 13 wherein each light emitting diode is connected to a switch to provide a current to a given light emitting diode.

15. The device of claim 14 wherein the intensity of the light can be adjusted by changing the amount of current applied to the light emitting diode.

16. The device of claim 1 further comprising a plurality of switches that can be controlled by a controller, wherein the light source having a plurality of light emitting diodes, wherein the switches control the current flow to the plurality of light emitting diodes, each light emitting diode having different light characteristics such as color temperature, light intensity, light focus, wherein the overall color temperature, light intensity and light focus are obtained by controlling the current flow to the plurality of light emitting diodes.

17. The device of claim 16 further comprising a controller wherein the controller is capable of adjusting the light intensity, the light color temperature and the light focus based on a desired table top setup lighting condition.

18. The device of claim 2, wherein the plurality of light sources are turned on or off by the plurality of switches to control the light intensity of a plurality of lights emitted by the plurality of light sources, and to control the color temperature of a plurality of lights emitted by the plurality of light sources.

19. The device of claim 17, wherein the color of the light emitted by each light source of the plurality of light sources can be changed by adding a plurality of color filters to the plurality of light sources.

20. The device of claim 19, wherein a plurality of focus changing devices are attached to the plurality of light sources based on desired light focus.
